(19) United States
(12) Patent Application Publication
(10) Pub. No.: US 2021/0402227 A1
(43) Pub. Date: Dec. 30, 2021

(54) COMBINATION FACE SHIELD AND FILTERING MASK SYSTEM

(71) Applicants: Lawrence Ralph Swonger, Lititz, PA (US); Thomas Paul Shissler, Lancaster, PA (US)

(72) Inventors: Lawrence Ralph Swonger, Lititz, PA (US); Thomas Paul Shissler, Lancaster, PA (US)

(21) Appl. No.: 17/304,827

(22) Filed: Jun. 25, 2021

Related U.S. Application Data
(60) Provisional application No. 62/705,401, filed on Jun. 25, 2020.

(51) Int. Cl. A62B 18/08; A41D 13/11; A62B 23/02

(52) U.S. Cl. CPC A62B 18/084; A62B 23/025; A41D 13/1161

(57) ABSTRACT

A protective face shield integrated with filtering mask and retainer band is provided. Proper fit and function of the integrated system is obtained by use of anchors on the protective shield and the retainer strap. These anchors properly position the filtering mask on the users face, maintaining proper fit around the user's face. The retainer strap maintains proper tension of the filtering mask against the users face, providing proper seal and maximizing user comfort. Unbuckling the retainer strap allows the face shield with filtering mask to be tilted up out of the way when not in use, while still mounted on the head. This integrated system provides the desired protection of face shield and filtering mask while significantly improving user comfort, reducing risk of cross-contamination from handling the filtering mask, and allowing a variety of filtering masks to be donned, doffed, and stored with the face shield.

### BACKGROUND OF THE INVENTION

The present invention relates to filtering masks and, more particularly, to a combination of a filtering mask with a face shield.

The use of filtering face masks has become much more prevalent worldwide throughout the years as the threat from pollution and communicable diseases has increased, particularly for those in close-packed and polluted urban settings, those performing work for short periods of time in industry, and those in the medical profession who don masks for short term surgical use. During viral outbreaks or pandemics, the proper use of filtering masks is essential for the general public as well.

The ear loops used around ears on standard surgical filtering masks irritate the ears over long term use. Moreover, each user has a different shaped head and face, requiring a mask mounting system to be adjustable to the user to obtain proper fit for that individual.

A filtering mask may become contaminated when adjusting, donning, or doffing the mask. Touching the inside of the mask with contaminated fingers or pulling the mask up or down onto one's contaminated face, neck, or head may compromise the cleanliness of the mask and the user's safety.

Filtering mask storage presents the same problems. When placed on a contaminated surface, the mask may get contaminated. When placed in a bag or container, the contaminated outside surface of the filtering mask touches the inside of the container, which may then contaminate the inside of the mask.

In addition to filtering masks, many people must wear face shields to eliminate the threat of viral contaminants being sprayed on their face, or in industry to protect them from other hazards, such as flying debris. In these instances, they must don a filtering face mask, tied to their head, then don a face shield for additional protection. Adjustment of the filtering facemask becomes difficult. Use of a separate face shield and filtering mask at the same time for protection against viral transmission is problematic for the user because the filtering mask can easily become contaminated when adjusting the mask or taking the mask on and off. Removing the facemask or raising and lowering it quickly to perform tasks such as drinking or eating becomes even more difficult to do without contaminating the mask.

Cumbersome full-face respirators may provide both spray protection and filtering but are not practical for the general public or in situations where a filtering cloth mask or surgical mask are adequate.

As can be seen, there is a need for a simple and comfortable way to obtain both spray protection and filtering mask protection that minimizes the risk of contaminating the filtering mask.

### SUMMARY OF INVENTION

The present invention provides an elegant solution for those who want or need to wear a protective face shield with a filtering mask. This invention allows the shield user to use a filtering mask of his or her choice and provides adjustment for good mask fit on each unique user. The invention also allows for adjustment of the face mask tension against the face to provide both a proper fit and a comfortable experience during extended use.

A user may easily don and doff both the protective face shield and filtering mask without touching, and potentially contaminating, the filtering mask. The filtering mask is stored in the shield, which prevents introducing contamination from a surface, in a bag, or around the user's head or neck. The inventive mask and shield system provides additional comfort for the user by eliminating the need for ear loops required with standard surgical or cloth masks.

### BRIEF DESCRIPTION OF THE DRAWINGS

FIG. 1 is a top plan view of a face shield and filtering mask system according to an embodiment of the present invention;

FIG. 2 (was removed);

FIG. 3 (was removed);

FIG. 4 is a perspective view of the system of FIG. 1;

FIG. 5 is another perspective view thereof;

FIG. 6 is a front elevation view thereof;

FIG. 7 is a right side elevation view thereof;

FIG. 8 is a rear elevation view thereof; and

FIG. 9 is a detail view from FIG. 7, upper anchor adjust

FIG. 10 is a detail view of FIG. 7, lower tension adjust.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

Broadly, an embodiment of the present invention provides a face shield with integral filtering facemask that easily mounts on the user's head using a headband adjusted for user comfort. The preinstalled filtering mask does not need to be touched when placing the system on the head for use, eliminating potential contamination from the user's hands. The face shield may tilt down to the in-use position and an attached retainer band may be pulled down around the back of the head, pre-adjusted to provide the perfect face mask tension against the individual user's face for proper function and for user comfort. When using a surgical mask, it is held in place by the face shield, eliminating irritation due to use of ear loops around ears to secure the mask. To remove the filtering mask, the user may simply unclasp the retaining band or strap and tilt the face shield up and out of the way, pivoting on the headband. The filtering mask does not need to be touched. When removing the unit from the head for storage, the filtering mask remains suspended in the shield instead of being placed on a contaminated surface or in a container where it could contaminate itself. The entire sequence of donning the unit, using the unit in raised or lowered position throughout the day, and doffing the unit for storage may be performed without touching and potentially contaminating the filtering mask, providing significantly improved functionality and safety for the user.

Initial setup may occur in a clean environment after a user's hands are washed. The user may install a clean filtering face mask, for example, by tying strings to attachment points on the visor or by using cord locks. The user may place the unit on his or her head and adjust the headband for comfort, then tilt the visor down to the in-use position. The user may then adjust the retainer band and face mask to provide the best fit, functionality, and comfort. The filtering mask may be moved up or down on the user's face using upper anchor adjust and lower tension adjust. The tension of the filtering mask against the face may be adjusted by adjusting the retaining band tension and lower tension adjust. Each time the filtering mask is replaced, the replacement mask may simply be installed into the same position as the removed mask to provide the same fit.

Once the initial setup is complete, the user may simply don the mask by placing the visor with attached mask on his or her head, flipping the visor down, and clasping the retaining band around back of head. The user does not need to touch the filtering mask again to put it on, take it off, or store it.

The headband may be attached to the face shield. The headband may have a basic adjustment or may have a ratcheting adjustment component, providing the user with greater adjustability and comfort.

The face shield and a face shield mount may be separate pieces or may be combined into a single component. If the face shield is suitable for mounting directly onto the headband itself, no face shield mount is required. In some embodiments, a face shield may be provided with attachment points formed therein. Existing face shields may be retrofitted to add attachment holes by drilling holes as shown on the drawings.

In an embodiment, the attachment holes along each side of the visor may be replaced by visor attachments providing the same functionality. These visor attachments may be manufactured by standard methods such as molding, punching, or three-dimensional (3D) printing. The visor attachments may be mounted to the visor using standard methods, such as mechanical fasteners, adhesive, ultrasonic welding, or a clamping action of the attachment component itself.

In some embodiments, a cord lock makes attachment of the filtering mask and retainer band simpler and more convenient. Alternatively, the user may forego the use of cord locks and simply tie the filtering mask and retainer band to the attachment points on the face shield.

Suitable face shields and face shield mounts, without the mounting holes or attachment points required on the inventive face shield, are commercially available from numerous manufacturers in different formats and may be modified for use in this invention. The face shield may be manufactured using injection molding, thermoforming, die cutting, or other standard manufacturing process for face shields. The face shield may be uncoated or may have a hard coat and/or antifog coating. The face shield and face shield mount may be a single molded, cut, or formed component or the face shield and the face shield mount may be separate components. If necessary, the face shield mount may be manufactured as a separate unit using the same types of standard manufacturing processes. The materials of manufacture for the face shield and face shield mount are not particularly limited and may include various types of plastics.

The retainer band may be an elastic or adjustable strap to provide tension, holding the facemask to the user's face. In another embodiment, a releasable tension mechanism between the headband and shield assembly may be used to provide the same functionality as the retainer band. The tension mechanism may use springs, elastic, or other flexible material to keep the filtering mask gently and comfortably forced against the face.

The filtering facemask may be provided with the face shield unit or may be supplied by the user.

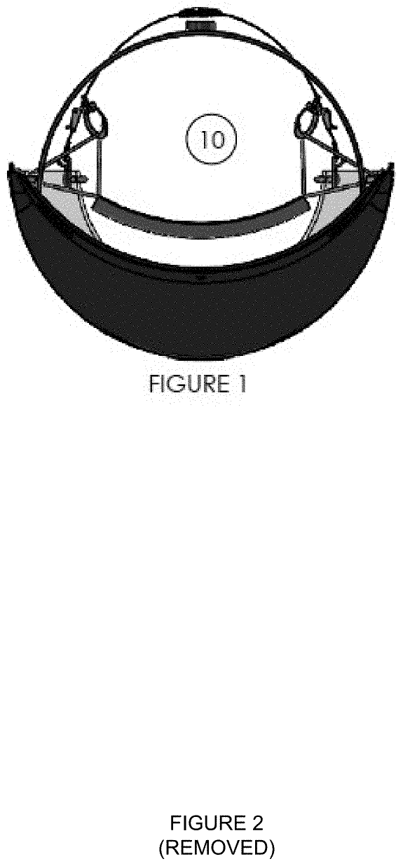

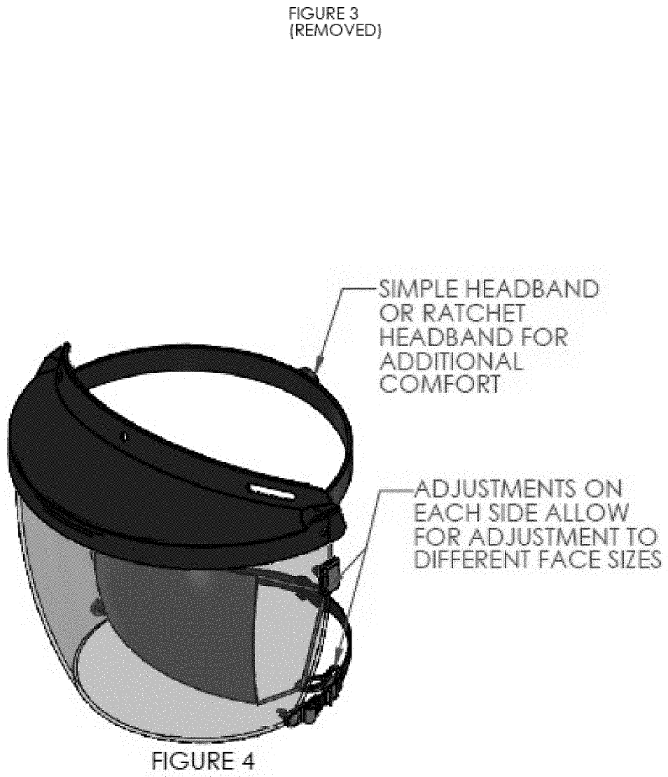

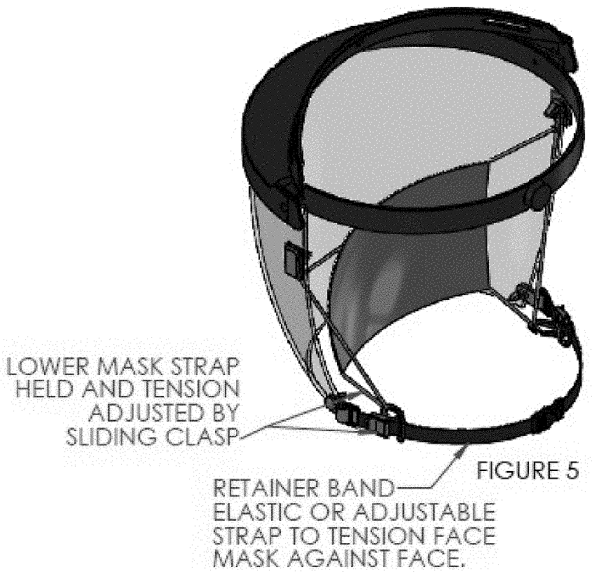

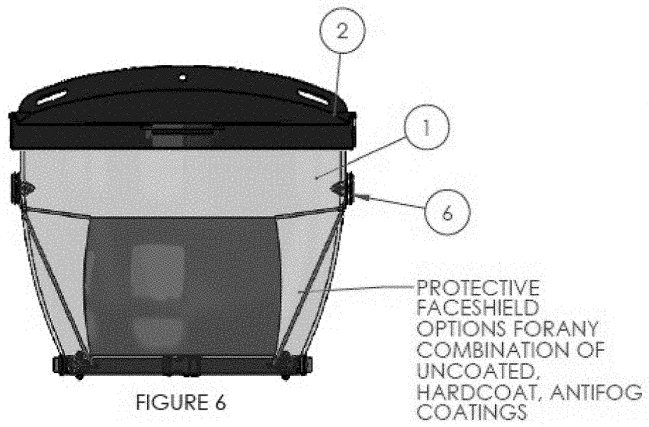

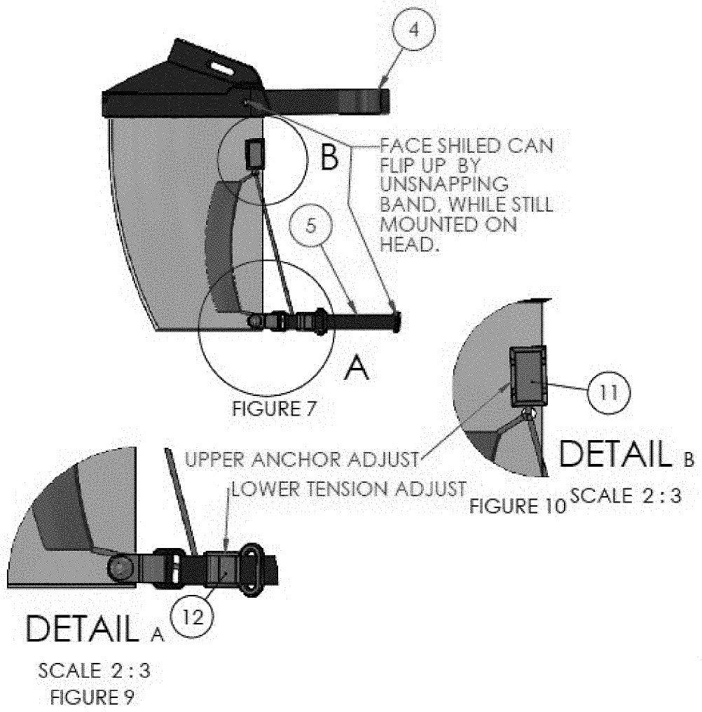

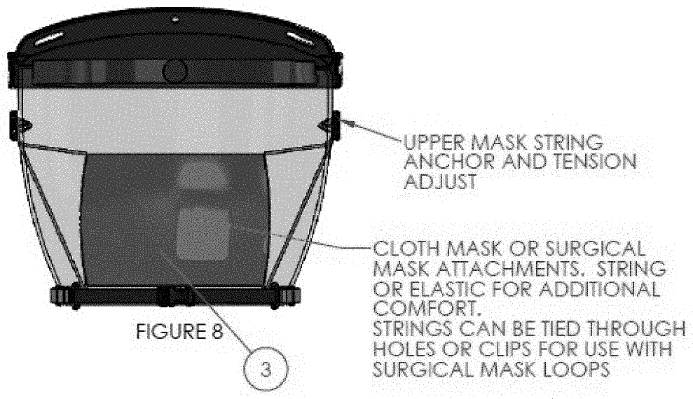

Referring now to FIGS. 1-9, a combined face shield and filtering face mask system 10 according to an embodiment of the invention is illustrated. FIG. 6 illustrates a face shield 1 attached to a face shield mount 2. Cord locks 6 may be provided to attach components to the face shield 1. FIG. 7 illustrates the face shield 1 in use position with a headband 4 attached thereto to secure the face shield/face mask system 10 around a user's head. A filtering facemask 3 may be held to the user's face by way of a retainer band 5. FIG. 8 illustrates attachment of the filtering face mask 3 to the face shield 1.

The filtering cloth or surgical mask 3 may attach to the face shield 1 either by tying the filtering mask 3 (e.g., with string) to attachment points on the face shield 1, or by use of cord locks 6, and retainer band 5 around the back of the user's head to provide gentle tension. The headband 4 may be attached to the shield assembly 1, 2 and may be used to mount the assembly to the user's head. The retainer band 5 may be attached to face shield 1 either by connection to attachment points on face shield 1, or by use of cord locks 6. The retainer band 5 may be attached to face shield 1 either by tying to attachment points on face shield 1, or by use of cord locks 6. The retainer band 5 may gently pull the face shield 1 back towards the face to provide proper tension of the filtering face mask 3 against the user's face.

The upper anchor adjust feature 11 is a critical feature, allowing the top edge of the cloth mask 3 to be adjusted to the proper height on the users face. The lower tension adjust 12 on the retainer band 5 is a critical feature, allowing the lower edge of the cloth mask 3 to be drawn down snuggly against the users face, providing good fit and seal on the users face.

It should be understood, of course, that the foregoing relates to exemplary embodiments of the invention and that modifications may be made without departing from the spirit and scope of the invention as set forth in the following claims.

1. A face shield and filtering mask system as shown and described, comprising:
A protective face shield,
a filtering mask,
a headband mounting system,
a retainer band,
fittings on the protective shield, and
fittings on the retainer band.

2. The face shield and filtering mask system of claim 1 further comprising:
Anchors and tension adjustments as described to ensure proper attachment of the upper mask cords to the protective shield, providing proper position and fit of the mask on the users face.

3. The face shield and filtering mask system of claim 1 further comprising:
Fittings on the retaining band allowing the retaining band tension to be adjusted, providing proper tension of the mask against the users face.

4. The face shield and filtering mask system of claim 1 further comprising:
Fittings on the retaining band allowing the retaining band to be unlatched when visor is being removed from user or when shield is being tilted up.

5. The face shield and filtering mask system of claim 1 further comprising:
Fittings on the retaining band, providing proper attachment and position of the lower mask cords and proper fit of the lower mask against the users face.

6. The face shield and filtering mask system of claim 1 further comprising:
Features on the headband to tilt the shield, with mask attached, up and away from users face when not in use.
